(19) United States
(12) Patent Application Publication
(10) Pub. No.: US 2010/0025597 A1
(43) Pub. Date: Feb. 4, 2010

(54) ION IMPLANTING DEVICE AND METHOD

(75) Inventor: Ryusuke Kasamatsu, Saga (JP)

Correspondence Address: GREENBLUM & BERNSTEIN, P.L.C., 1950 ROLAND CLARKE PLACE, RESTON, VA, 20191, US

(73) Assignee: SUMCO CORPORATION, Tokyo (JP)

(21) Appl. No.: 12/511,447

(22) Filed: Jul. 29, 2009

(30) Foreign Application Priority Data
Jul. 31, 2008 (JP) 2008-198864

(51) Int. Cl. G21K 5/10

(52) U.S. Cl. 250/492.21; 250/492.22

(57) ABSTRACT

To reduce the occurrence of stripes in the oscillation direction of a semiconductor wafer which might occur when ion implantation scanning is performed by radiating ions onto the semiconductor wafer while oscillating the semiconductor wafer like a pendulum, the ion implantation of the present invention involves radiating ions while rotating a plurality of semiconductor wafers 28 arranged on a concentric circle circumference around a rotary shaft of a rotary body rotated by a rotary driving mechanism and while oscillating the rotary body like a pendulum by use of an oscillation mechanism which oscillates the rotary body, and scanning the ions over an entire surface of the semiconductor wafer by controlling the rotary driving mechanism, the oscillation mechanism and the radiation timing of the ions. In particular, the whole ion implantation process is divided into two times; an ion implantation scanning pitch of ion beam spots 42 for the second time is set between intervals of an ion implantation scanning pitch in the oscillation direction A of the wafer of ion beam spots 40 for the first time, whereby periodical irregularities of the SOI layer thickness and the BOX layer thickness in the oscillation direction of a wafer are suppressed and the occurrence of stripes is reduced.

### BACKGROUND OF THE INVENTION

1. Field of the Invention

The present invention relates to an ion implanting device and an ion implanting method and, more particularly, to a technique for reducing stripes on a semiconductor wafer which occur due to ion implantation into the semiconductor wafer.

2. Description of the Related Art

In recent years, SOI (Silicon On Insulator) wafers have been used in order to accomplish high-speed and low-power-consumption designs of integrated circuits, such as LSI (Large Scale Integration). An SOI wafer is constructed by burying an insulating layer formed of an oxide film between a silicon support and a surface silicon layer.

One of the manufacturing methods of such SOI wafers used is referred to as the SIMOX (Separation by IMplanted OXygen) process, which involves implanting, for example, oxygen ions into a silicon wafer and thereafter performing heat treatment to form an insulating layer formed of an oxide film, i.e., a BOX (Buried OXide) layer.

As described in JP 2002-231177 A1, an ion implanting device used in the SIMOX process is composed of a plurality of semiconductor wafer holders arranged on a concentric circle circumference around the rotary shaft of a rotary disk rotated by a motor, an oscillation mechanism which oscillates the rotary disk, the wafer holder and the like as a unit like a pendulum, ion implantation means which radiates an ion beam onto a semiconductor wafer, and the like. And it is known that the ion beam is radiated while each semiconductor wafer is being rotated by the motor and is being oscillated like a pendulum by use of the oscillation mechanism, whereby the ion beam is scanned over an entire surface of the wafer.

### SUMMARY OF THE INVENTION

Patent Document 1: JP 2002-231177 A1 Incidentally, in the ion implanting method described in JP 2002-231177 A1, no consideration is given to the suppression of the occurrence of exterior stripes on the wafer surface ascribed to periodical thickness irregularities of an SOI layer and a BOX layer in the oscillation direction of a semiconductor wafer.

That is, the current density within an ion beam is not entirely uniform. In general, the density in a center portion is high and the nearer to the outer circumference, the lower the density. For this reason, when ion implantation scanning is performed multiple times in the oscillation direction of a semiconductor wafer by radiating the ion beam onto the semiconductor wafer while oscillating the semiconductor wafer, the ion implantation scanning position in the oscillation direction of the semiconductor wafer may meet again each time in a portion where the ion beam current density is high or low. As a result, when there are positions where ion implantation is performed in an overlapping manner in portions where the ion beam current density is high or low, a thickness difference occurs in an SOI layer and a BOX layer, and stripes may occur when this thickness difference occurs periodically in the oscillation direction.

Therefore, the present invention has as its object to reduce the occurrence of stripes in the oscillation direction of a semiconductor wafer when ion implantation scanning is performed by radiating ions onto a semiconductor wafer while oscillating the semiconductor wafer.

The ion implanting device for semiconductor wafers of the present invention includes a rotary body rotated by a rotary driving mechanism, a plurality of arms radially extended around a rotary shaft of the rotary body, a support disk for a semiconductor wafer provided on each of the arms, an oscillation mechanism which oscillates the rotary body, each of the arms, and each of the support disks as a unit like a pendulum, and ion implantation means which radiates ions onto the semiconductor wafer which is oscillated by the oscillation mechanism while being rotated by the rotary driving mechanism, and the ion implanting device scans the ions over an entire surface of the semiconductor wafer by controlling the rotary driving mechanism, the oscillation mechanism and the radiation timing of the ions.

In particular, to solve the above-described problem, the ion implantation over the entire surface of the semiconductor wafer is performed multiple times by changing at least one of conditions: the oscillation start position of the semiconductor wafer and the radiation timing of the ions, whereby ion implantation positions in the oscillation direction of the semiconductor wafer during the ion implantation of each time are shifted from each other.

That is, all steps of the ion implantation process for the semiconductor wafer are divided into multiple times and ion implantation positions in the oscillation direction of the semiconductor wafer in each time are shifted from each other, whereby the ion implantation positions in the oscillation direction of the semiconductor wafer are not affected by the ion beam current density distribution, with the result that ion implantation is evenly performed. As a result, compared to a case where ion implantation positions are not shifted from each other, the thickness of an SOI layer and a BOX layer is made uniform and it is possible to reduce the occurrence of stripes in the oscillation direction of the semiconductor wafer.

Ion implantation positions in the oscillation direction can be shifted, for example, by shifting the oscillation start position of the semiconductor wafer each time. Also, it is possible to shift ion implantation positions in the oscillation direction by shifting the ion radiation timing each time without changing the oscillation start position of the semiconductor wafer. Ion implantation positions in the oscillation direction may also be shifted by changing the both conditions of the oscillation start position of the semiconductor wafer and the ion radiation timing.

In this case, it is preferred that the ion implantation over the entire surface of the semiconductor wafer be performed twice by changing at least one of conditions: the oscillation start position of the semiconductor wafer and the radiation timing of the ions, and that an ion implantation scanning pitch of the second ion implantation be set between intervals of an ion implantation scanning pitch in the oscillation direction of the semiconductor wafer during the first ion implantation.

That is, the second scanning pitch is set between intervals of the first scanning pitch in the oscillation direction of the semiconductor wafer by changing the condition setting for the first ion implantation and the condition setting for the second ion implantation, whereby places with enhanced beam current density are shifted, canceling out high and low current densities of the beam and leading to uniform ion implantation. As a result, compared to the case where the ion implantation positions are not shifted from each other, the thickness of the SOI layer and the BOX layer is made uniform and it is possible to reduce the occurrence of stripes in the oscillation direction of the semiconductor wafer.

The method of implanting ions into a semiconductor wafer of the present invention involves radiating ions while rotating a plurality of semiconductor wafers arranged on a concentric circle circumference around a rotary shaft of a rotary body to be rotated by a rotary driving mechanism by use of the rotary driving mechanism and while oscillating the rotary body by use of an oscillation mechanism which oscillates the rotary body, and scanning the ions over the entire surface of the semiconductor wafer by controlling the rotary driving mechanism, the oscillation mechanism and the radiation timing of the ions.

In particular, to solve the above-described problem, the ion implantation over the entire surface of the semiconductor wafer is performed multiple times by changing at least one of conditions: the oscillation start position of the semiconductor wafer and the radiation timing of the ions, whereby ion implantation positions in the oscillation direction of the semiconductor wafer during the ion implantation of each time are shifted from each other.

For example, it is preferred that the ion implantation over the entire surface of the semiconductor wafer be performed twice by changing at least one of conditions: the oscillation start position of the semiconductor wafer and the radiation timing of the ions, and that an ion implantation scanning pitch of the second ion implantation be set between intervals of an ion implantation scanning pitch in the oscillation direction of the semiconductor wafer during the first ion implantation.

According to the present invention, it is possible to reduce the occurrence of stripes in the oscillation direction of a semiconductor wafer when ion implantation scanning is performed by radiating ions onto a semiconductor wafer while oscillating the semiconductor wafer.

### BRIEF DESCRIPTION OF THE DRAWINGS

FIG. 1 is a side view of the general schematic construction of an ion implanting device of this embodiment;

FIG. 2 is a front view of the general schematic construction of an ion implanting device of this embodiment and explains the operating condition of a semiconductor wafer during ion implantation;

FIG. 3 is a schematic diagram to explain an ion scanning method of the ion implanting device of the embodiment;

FIGS. 4A and 4B are diagrams to explain a conventional ion scanning method and the ion scanning method of this embodiment by making a comparison between the two; and

FIGS. 5A and 5B are diagrams showing the effect of ion implantation by the ion implanting device of this embodiment.

### DETAILED DESCRIPTION OF THE INVENTION

Hereinafter, an embodiment of an ion implanting device and an ion implanting method to which the present invention is applied will be described. Incidentally, in the following descriptions, same numerals refer to parts of the same function and redundant descriptions of such parts are omitted.

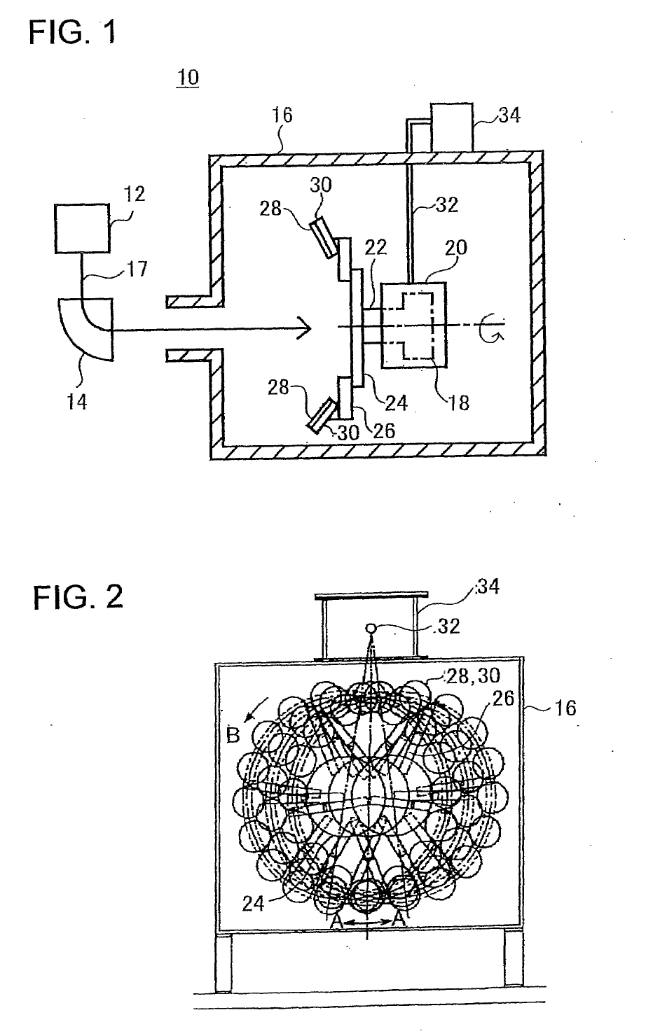

FIG. 1 is a side view of the general schematic construction of an ion implanting device of this embodiment. FIG. 2 is a front view of the general schematic construction of an ion implanting device of this embodiment and explains the operating condition of a semiconductor wafer during ion implantation.

As shown in FIG. 1, an ion implanting device 10 is constructed to have ion implantation means which implants ions of, for example, oxygen into an object to be treated, and a treatment chamber 16 which houses a semiconductor wafer of, for example, silicon into which ions are to be implanted as the object to be treated. The ion implantation means is constructed to include an ion source 12, a mass separator 14 and the like.

The ion source 12 is connected to the mass separator 14 via an unillustrated pipe which is evacuated to a vacuum. The ion source 12 is adapted to generate an ion beam 17 by, for example, oxygen ions by use of microwaves and to emit the generated ion beam 17 to the mass separator 14 side. The mass separator 14 is connected to the treatment chamber 16 via an unillustrated pipe which is evacuated to a vacuum. The mass separator 14 is adapted to deflect the ion beam 17 from the ion source 12 substantially 90 degrees by applying an electromagnetic force to the ion beam 17 and to separate and extract an ion species having a necessary mass, for example, only oxygen ions, from the ion beam 17 and cause the ions to enter the treatment chamber 16.

Within the treatment chamber 16, there are housed a motor 18 as a rotary driving mechanism, a motor box 20 which houses the motor 18, a rotary shaft 22 rotated by the motor 18, a rotary body 24 fitted onto the rotary shaft 22, a plurality of arms 26 radially extended around the rotary shaft 22 of the rotary body 24, and a support disk 30 for a semiconductor wafer 28 provided in a forward end portion of each of the arms 26.

An oscillation mechanism 34 which oscillates the motor 18, the rotary body 24, the arm 26, the support disk 30 etc. within the treatment chamber 16 like a pendulum via an oscillating arm 32 connected to the motor box 20 is provided on the top surface of the treatment chamber 16.

As shown in FIG. 2, the ion implanting device of this embodiment implants ions by use of the ion implantation means by oscillating the semiconductor wafer 28 like a pendulum as indicated by arrows A by use of the oscillation mechanism 34 and rotating the semiconductor wafer 28 around the rotary shaft 22 as indicated by arrow B by use of the motor 18.

As shown in FIG. 1, in the ion implanting device 10 of this embodiment, the support disk 30 is rotated during ion implantation with the disk surface faced toward the direction substantially orthogonal to the rotary shaft 22 and, therefore, a centrifugal force acts on the semiconductor wafer 28 placed on the support disk 30. In order to prevent the semiconductor wafer 28 from flying out due to this centrifugal force, each of the support disks 30 is slightly inclined so that the disk surface faces the rotary shaft 22 and is constructed to receive the components of the centrifugal force on the disk surface.

Because the inclination of the support disk cannot be made very large due to the constraints of ion implantation, each of the support disks 30 is provided with an unillustrated stopper so as to contact with a peripheral edge portion of the placed semiconductor wafer 28 on the side remote from the rotary shaft 22 of the rotary body 24. There is also provided an unillustrated back-surface pin which abuts against the back surface of the placed semiconductor wafer 28 on the side near the rotary shaft 22 of the rotary body 24.

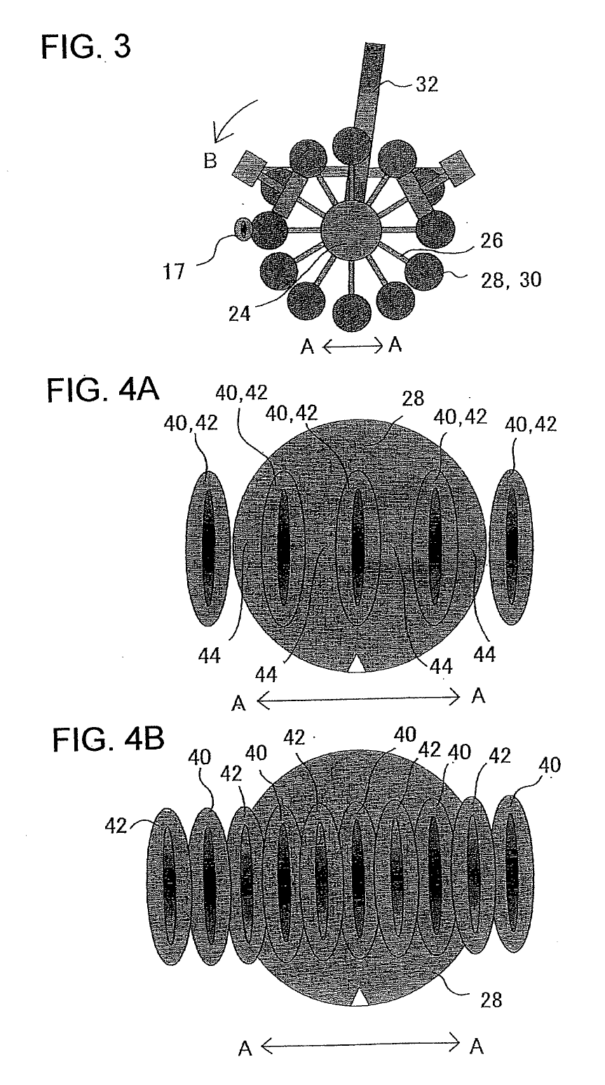

FIG. 3 is a schematic diagram to explain the ion scanning method of the ion implanting device of this embodiment. As shown in FIG. 3, in the ion implanting device 10 of this embodiment, the ion implantation means is provided in a fixed position and an ion beam 17 is radiated onto a fixed position. The semiconductor wafer 28 is rotated by the motor 18 in the direction of arrow B shown in the figure and is oscillated by the oscillation mechanism 34 in the direction of arrows A shown in the figure. And the ion beam 17 is scanned over the entire surface of the semiconductor wafer 28 by controlling the rotation speed and rotation start position of the semiconductor wafer 28 by the motor 18, the oscillation speed and oscillation start position by the oscillation mechanism 34, the radiation timing of ions by the ion implantation means, and the like.

Incidentally, in FIG. 1, for the sake of simplicity of explanation, only the pair of upper and lower arms 26, the semiconductor wafer 28 and the support disk 30 are shown. Practically, however, as shown in FIG. 2 or FIG. 3, on a concentric circle circumference around the rotary shaft 22 of the rotary body 24, there are arranged a plurality of (for example, twelve or eighteen) semiconductor wafers 28 along with respective arms 26 and support disks 30.

In FIG. 1, because only the pair of upper and lower arms 26, the semiconductor wafer 28 and the support disk 30 are shown, the ion beam 17 is not radiated onto the semiconductor wafer 28. Practically, however, as shown in FIG. 3, it is ensured that the ion beam 17 is radiated onto the semiconductor wafer 28 positioned horizontally with respect to the rotary shaft 22 of the rotary body 24. For the sake of convenience of explanation, in the explanation of this embodiment, the diameter of the ion beam 17 to be radiated onto the semiconductor wafer 28 is shown to be larger than an actual diameter.

Incidentally, in an ion implanting method which involves thus performing ion implantation scanning in the oscillation direction of the semiconductor wafer 28 by radiating ions onto the semiconductor wafer 28 while oscillating the semiconductor wafer 28 like a pendulum, exterior stripes may occur due to periodical thickness irregularities of an SOI layer and a BOX layer in the oscillation direction of the semiconductor wafer.

That is, when ion implantation scanning in the oscillation direction of the semiconductor wafer 28 is performed multiple times by radiating the ion beam 17 onto the semiconductor wafer 28 while oscillating the semiconductor wafer 28, high or low current density of the beam may meet again depending on the ion implantation scanning position in the oscillation direction of the semiconductor wafer 28. As a result, a difference occurs in the thickness of the SOI layer and the BOX layer between a position where the portion of high beam current density meets again and a position where the portion of low beam current density meets again. This difference appearing periodically in the oscillation direction may cause stripes to occur.

To cope with this problem, in the ion implanting device 10 of this embodiment, the ion implementation over the entire surface of the semiconductor wafer 28 is performed multiple times by changing at least one of conditions: the oscillation start position of the semiconductor wafer 28 and the radiation timing of the ions, and ion implantation positions in the oscillation direction of the semiconductor wafer 28 during the ion implantation of each time are shifted from each other.

In other words, all steps of the ion implantation process for the semiconductor wafer 28 are divided into multiple times and ion implantation positions in the oscillation direction of the semiconductor wafer 28 in each time are shifted from each other.

FIGS. 4A and 4B are diagrams to explain a conventional ion scanning method and the ion scanning method of this embodiment by making a comparison between the two. FIG. 4A is a schematic diagram of a case where the whole ion implantation process is carried out without a change of ion scanning conditions in the same manner as in the conventional art. FIG. 4B is a schematic diagram of a case where the whole ion implantation process is carried out by dividing the process into two times by changing at least one of conditions: the oscillation start position of the semiconductor wafer 28 and the radiation timing of the ions.

Incidentally, for the sake of convenience of explanation, FIGS. 4A and 4B are such that scanning is performed when the ion beam moves with respect to the semiconductor wafer 28 whose position is fixed. Practically, however, the radiation positions of the ion beam are fixed and ion implantation scanning in the oscillation direction is performed by the oscillation of the semiconductor wafer.

When ion implantation scanning is performed multiple times for the semiconductor wafer in the case where the whole ion implantation process is carried out without a change of ion scanning conditions as shown in FIG. 4A, the result is that the portion of high current density or the portion of low current density meets again in the ion implantation scanning positions in the oscillation direction of the semiconductor wafer indicated by arrows A in the figure. That is, assuming that ion beam spots in the first half of the whole ion implantation process are regarded as ion beam spots 40 of the first time and that ion beam spots in the latter half are regarded as ion beam spots 42 of the second time, then in FIG. 4A the portions of high beam current density or the portions of low beam current density in the ion beam spots 40 of the first time and the ion beam spots 42 of the second time are radiated in the same positions.

As a result, there occur positions where portions of high current density of the ion implantation beam overlap (positions where the ion beam spots 40 of the first time meet the ion beam spots 42 of the second time) and positions 44 where portions of low beam current density between these positions overlap. A difference occurs in the thickness of an SOI layer and a BOX layer between a position where the portion of high beam current density meets again and a position where the portion of low beam current density meets again. This difference appearing periodically in the oscillation direction causes stripes to occur.

In contrast to this, in the ion implanting device of this embodiment, the whole ion implantation process is divided into two times (the first half and the latter half), and as shown in FIG. 4B, an ion implantation scanning pitch for the ion beam spots 42 of the second time is set between intervals of an ion implantation scanning pitch in the oscillation direction of the semiconductor wafer 28 for the ion beam spots 40 of the first time.

More concretely, different scanning positions are used for the first ion implementation and the second ion implementation by changing either the oscillation start position of the semiconductor wafer 28 or the radiation timing of the ions or by changing both of these conditions for the first ion implementation and the second ion implementation.

According to this embodiment, as shown in FIG. 4B, ion implantation is evenly performed along the oscillation direction of the semiconductor wafer 28 and the positions 44 where ion implantation is not performed are substantially eliminated. As a result, compared to the case of FIG. 4A where ion implantation positions are not shifted from each other, the thickness of the SOI layer and the BOX layer is made uniform and it is possible to reduce the occurrence of stripes in the oscillation direction of the semiconductor wafer 28.

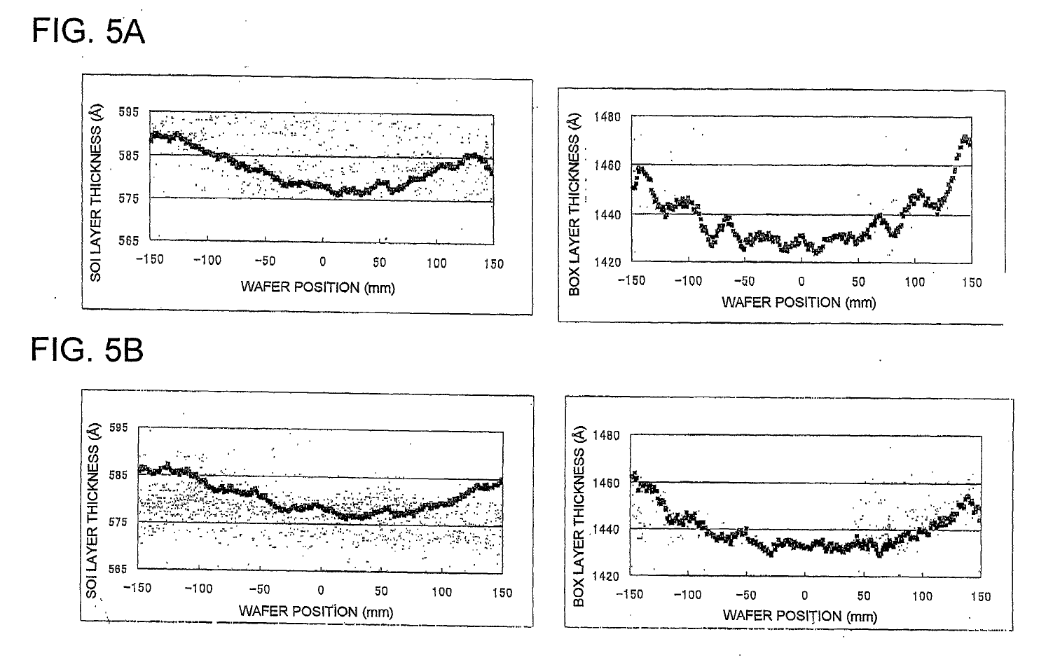

FIGS. 5A and 5B are diagrams showing the effect of ion implantation by the ion implanting device of this embodiment. FIG. 5A provides diagrams showing the SOI layer thickness and the BOX layer thickness of a semiconductor wafer obtained in a case where the whole ion implantation process was carried out without a change of ion scanning conditions in the same manner as in the conventional art. FIG. 5B provides diagrams showing the SOI layer thickness and the BOX layer thickness of a semiconductor wafer obtained in a case where the ion implantation by the ion implanting device of this embodiment was carried out.

In FIG. 5A, a periodical variation is seen in both the SOI layer thickness and the BOX layer thickness and this appears as exterior stripes on the surface of a semiconductor wafer. In contrast to this, in FIG. 5B, a periodical variation is suppressed in both the SOI layer thickness and the BOX layer thickness compared to FIG. 5A. As a result of this, the occurrence of exterior stripes in the oscillation direction of the semiconductor wafer is reduced.

Incidentally, although in this embodiment there is shown an example in which the whole ion implantation process is divided into two times and ion scanning positions in the oscillation direction of the semiconductor wafer are changed for the first time and the second time, the present invention is not limited to this. That is, also by dividing the whole ion implantation process into multiple times of not less than three times and shifting the ion implantation positions from each other in the oscillation direction of the semiconductor wafer during the ion implantation of each time, similarly it is possible to reduce the occurrence of stripes by suppressing the periodical irregularities of the SOI layer thickness and the BOX layer thickness along the oscillation direction of the semiconductor wafer.

What is claimed is:

1. An ion implanting device, comprising:
a rotary body rotated by a rotary driving mechanism;
a plurality of arms radially extended around a rotary shaft of the rotary body;
a support disk for a semiconductor wafer provided on each of the arms;
an oscillation mechanism which oscillates the rotary body, each of the arms, and each of the support disks as a unit like a pendulum; and
ion implantation means which radiates ions onto the semiconductor wafer which is oscillated by the oscillation mechanism while being rotated by the rotary driving mechanism,
the ion implanting device scanning the ions over an entire surface of the semiconductor wafer by controlling the rotary driving mechanism, the oscillation mechanism and the radiation timing of the ions,
wherein the ion implantation over the entire surface of the semiconductor wafer is performed multiple times by changing at least one of conditions: the oscillation start position of the semiconductor wafer and the radiation timing of the ions, whereby ion implantation positions in the oscillation direction of the semiconductor wafer during the ion implantation of each time are shifted from each other.

2. The ion implanting device according to claim 1, wherein the ion implantation over the entire surface of the semiconductor wafer is performed twice by changing at least one of conditions: the oscillation start position of the semiconductor wafer or the radiation timing of the ions, and an ion implantation scanning pitch of a second ion implantation is set between intervals of an ion implantation scanning pitch in the oscillation direction of the semiconductor wafer during a first ion implantation.

3. An ion implanting method, comprising:
radiating ions while rotating a plurality of semiconductor wafers arranged on a concentric circle circumference around a rotary shaft of a rotary body rotated by a rotary driving mechanism by use of the rotary driving mechanism and while oscillating the rotary body by use of an oscillation mechanism which oscillates the rotary body; and
scanning the ions over an entire surface of the semiconductor wafer by controlling the rotary driving mechanism, the oscillation mechanism and the radiation timing of the ions,
wherein the ion implantation over the entire surface of the semiconductor wafer is performed multiple times by changing at least one of conditions: the oscillation start position of the semiconductor wafer and the radiation timing of the ions, whereby ion implantation positions in the oscillation direction of the semiconductor wafer during the ion implantation of each time are shifted from each other.

4. The ion implanting method according to claim 3, wherein the ion implantation over the entire surface of the semiconductor wafer is performed twice by changing at least one of conditions: the oscillation start position of the semiconductor wafer and the radiation timing of the ions, and an ion implantation scanning pitch of a second ion implantation is set between intervals of an ion implantation scanning pitch in the oscillation direction of the semiconductor wafer during a first ion implantation.
